(19) United States
(12) Patent Application Publication
(10) Pub. No.: US 2002/0041344 A1
(43) Pub. Date: Apr. 11, 2002

(54) Method for reducing radiation of a cathode-ray tube display

(76) Inventor: Hsich Chang Fa, Taipei (TW)

Correspondence Address: RABIN & CHAMPAGNE, PC, 1101 14TH STREET, NW, SUITE 500, WASHINGTON, DC, 20005, US

(21) Appl. No.: 09/968,875

(22) Filed: Oct. 3, 2001

(30) Foreign Application Priority Data
Oct. 4, 2000 (TW) 89120709

(51) Int. Cl. H04N 5/65

(52) U.S. Cl. 348/819; 348/818

(57) ABSTRACT

A method and an apparatus for reducing radiation of a cathode-ray tube display are provided. According to the invention, the voltage signals of the two terminals of the horizontal deflection yoke are pulses of equal amplitude but opposite polarity. Thus, at positions which is equally apart from the two terminals of the horizontal deflection yoke, the electromagnetic radiation generated from the two terminals during operation of the cathode-ray tube can be substantially cancelled. Thus, the influence of the electromagnetic radiation from the horizontal deflection yoke on a user sits in front of the cathode-ray tube display is effectively reduced to a minimum. Further, it is only required to modify the way of winding in the flyback transformer and the cathode-ray tube remains unchanged. In this way, it requires almost no additional power dissipation for the reduction of the undesired electromagnetic radiation. Therefore, the electromagnetic radiation reduction is achieved and the cost is lowered.

This application incorporates by reference Taiwanese application Serial No. 89102709, filed on Oct. 4, 2000.

### BACKGROUND OF THE INVENTION

1. Field of the Invention

The invention relates in general to a method for reducing electromagnetic radiation and an apparatus therefor, and more particularly to a method for reducing electromagnetic radiation near a cathode-ray tube display and an apparatus therefor.

2. Description of the Related Art

In the operation of cathode ray tube (CRT) displays, electromagnetic radiation is generated. Since electromagnetic radiation may have negative influence on human beings, the magnitude of electromagnetic radiation generated by CRT displays should be concerned in the design of the CRT displays so that the influence of the generated radiation on users is reduced to a minimal level. In a CRT display, the electromagnetic radiation is substantially generated from a deflection yoke. The deflection yoke is to deflect an electron beam in order to achieve horizontal or vertical scanning. The deflection yoke essentially consists of two pairs of coils: horizontal deflection yoke for deflecting the electron beam in the horizontal direction, and vertical deflection yoke for deflecting the electron beam in the vertical direction. The horizontal and vertical deflection yokes are driven by a train of sawtooth waveform pulses. In addition, a sawtooth waveform current at the frequency of about 30 kHz or above is applied to the horizontal deflection yoke while a sawtooth waveform current at the frequency of about 60 Hz or above is applied to the vertical deflection yoke. The horizontal deflection yoke generates greater electromagnetic radiation than the vertical deflection yoke in strength. Therefore, reducing the electromagnetic radiation generated from the horizontal deflection yoke of the CRT display is among the important development topics in the display industry.

FIG. 1 is a schematic diagram illustrating an equivalent circuit of a conventional horizontal deflection circuit in a CRT. The horizontal deflection circuit includes a transistor Q, a capacitor C, a damping diode D, a capacitor Cs, and a horizontal deflection yoke DY. By the use of the resonator provided by the capacitor C with the horizontal deflection yoke DY as well as the switching operation by using the transistor Q and damping diode D, a sawtooth waveform current is generated so that the horizontal deflection yoke DY deflects an electron beam in the horizontal direction. The output voltage of the horizontal deflection yoke DY is increased and rectified by a flyback transformer FT, resulting in a voltage as an anode voltage and focusing voltage for the CRT. In order to cause the transistor Q to turn on and off alternately, a signal S1 is applied to the transistor Q. Besides, the capacitor Cs is a compensation capacitor for S-character correction, compensating for image distortion in a horizontal direction.

FIG. 2 shows the waveform diagrams for the conventional horizontal deflection circuit shown in FIG. 1. The current flowing through the horizontal deflection yoke DY is denoted by I_{L}, the current flowing through the capacitor C is represented by I_{C}, and V_{C} is the voltage across the capacitor C. Initially, a constant voltage V_{CC} is applied to the capacitor Cs for charging the capacitor Cs. The transistor Q, during the period (a) as indicated in FIG. 2, is turned on, and the current I_{L} from the capacitor Cs begins to flow through the horizontal deflection yoke DY towards the transistor Q, where the current I_{L} increases linearly. Next, during the period (b), the transistor Q is turned off so that oscillation starts with the capacitor C and the horizontal deflection yoke DY as so to cause the current I_{L} through the horizontal deflection yoke DY and the current I_{C} through the capacitor C to be sinusoidal. When the sinusoidal currents I_{L} reaches to a minimum value so that the damping diode D conducts, the current I_{L} begins to increase linearly as shown in the period (c). If the transistor Q is then turned on before the damping diode D is off, the current I_{L} continues to increase linearly. In this manner, if the transistor Q is alternately switched on and off, the current I_{L} flowing through the horizontal deflection yoke DY becomes a train of sawtooth waveform pulses. In addition, the voltage V_{C}, as shown in FIG. 2, across the capacitor C varies with the current I_{C} as a train of pulses with an amplitude of Vₚ. Since there are variations in voltage and current at the collector of the transistor Q, electromagnetic radiation is generated.

In order to reduce the radiation from the horizontal deflection yoke DY of a CRT, the conventional approach is to arrange at least one reduction conductor, such as a coil, in close proximity to the CRT so that a reduction magnetic field is generated against the magnetic stray field generated by the horizontal deflection yoke DY. However, this conventional approach needs to add the reduction conductor to the CRT display, resulting in an increase in the cost and additional power dissipation. Thus, it is required to find another approach to the reduction of the radiation of the magnetic stray field.

### SUMMARY OF THE INVENTION

It is therefore an object of the invention to provide a method for reducing the radiation of a cathode ray tube display, and an apparatus therefor. By changing the reference voltage of the horizontal deflection yoke, the radiation generated by the horizontal deflection yoke is substantially cancelled. In this manner, the undesired electromagnetic radiation is reduced to a minimum without using any modification of the cathode-ray tube and consuming additional power.

The invention achieves the above-identified object by providing a method for reducing radiation of a cathode-ray tube display. The cathode-ray tube display includes a horizontal deflection circuit for deflecting an electron beam of the cathode-ray tube horizontally. The horizontal deflection circuit includes a transistor, a damping diode, a capacitor, a compensation capacitor, and a horizontal deflection yoke. The damping diode is coupled to the capacitor in parallel, and coupled between a collector and an emitter of the transistor. The horizontal deflection yoke is coupled between the collector of the transistor and the compensation capacitor. The compensation capacitor is coupled between the horizontal deflection yoke and the emitter of the transistor. The transistor, the damping diode, and the capacitor are used so that a sawtooth waveform current flows through the horizontal deflection yoke, and the compensation capacitor is used for compensating horizontal image distortion. The method includes applying a first voltage signal and a second voltage signal to the collector and the emitter of the transistor respectively, wherein the first voltage signal is a train of first pulses and the second voltage signals is a train of second pulses, the first and second pulses have equal amplitude, and the first and second pulses are of opposite polarity.

The invention achieves the above-identified object by providing an apparatus for reducing radiation of a cathode-ray tube display. The cathode-ray tube display includes a horizontal deflection circuit for deflecting an electron beam of the cathode-ray tube horizontally. The horizontal deflection circuit includes a transistor, a damping diode, a capacitor, a compensation capacitor, and a horizontal deflection yoke. The damping diode is coupled to the capacitor in parallel, and coupled between a collector and an emitter of the transistor. The horizontal deflection yoke is coupled between the collector of the transistor and the compensation capacitor. The compensation capacitor is coupled between the horizontal deflection yoke and the emitter of the transistor. The transistor, the damping diode, and the capacitor are used so that a sawtooth waveform current flows through the horizontal deflection yoke, and the compensation capacitor is used for compensating horizontal image distortion. The apparatus includes a flyback transformer having a primary winding. The primary winding includes a first coil and a second coil. A first terminal of the first coil is coupled to the collector of the transistor and a second terminal of the first coil is coupled to a direct current (DC) supply voltage. A first terminal of the second coil is coupled to ground and a second terminal of the second coil is coupled to the emitter of the transistor.

Other objects, features, and advantages of the invention will become apparent from the following detailed description of the preferred embodiments with reference to the accompanying drawings.

### BRIEF DESCRIPTION OF THE DRAWINGS

FIG. 1 (Prior Art) is a schematic diagram illustrating an equivalent circuit of the deflection yoke of a conventional cathode-ray tube display.

FIG. 2 (Prior Art) shows waveform diagrams of voltage and currents of the components in the equivalent circuit shown in FIG. 1.

FIG. 3 is a schematic diagram of an equivalent circuit of a deflection yoke for reducing stray magnetic field in a cathode-ray tube display according a preferred embodiment of the invention.

FIG. 4 shows waveform diagrams of voltage and currents of the components in the equivalent circuit shown in FIG. 3.

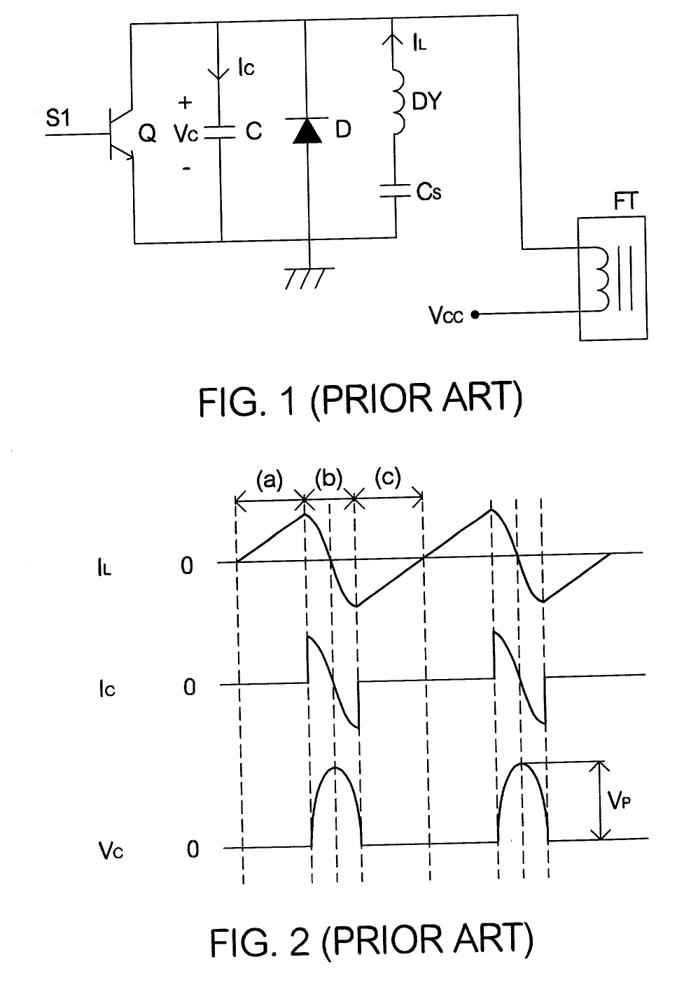

### DESCRIPTION OF THE PREFERRED EMBODIMENT

According to the invention, voltage signals provided at two terminals of a deflection yoke for a cathode-ray tube display are identical in amplitude and phase but are of opposite polarity. Thus, the electromagnetic radiation generated from the two terminals of the deflection yoke is cancelled in positions that are equally apart from the two terminals.

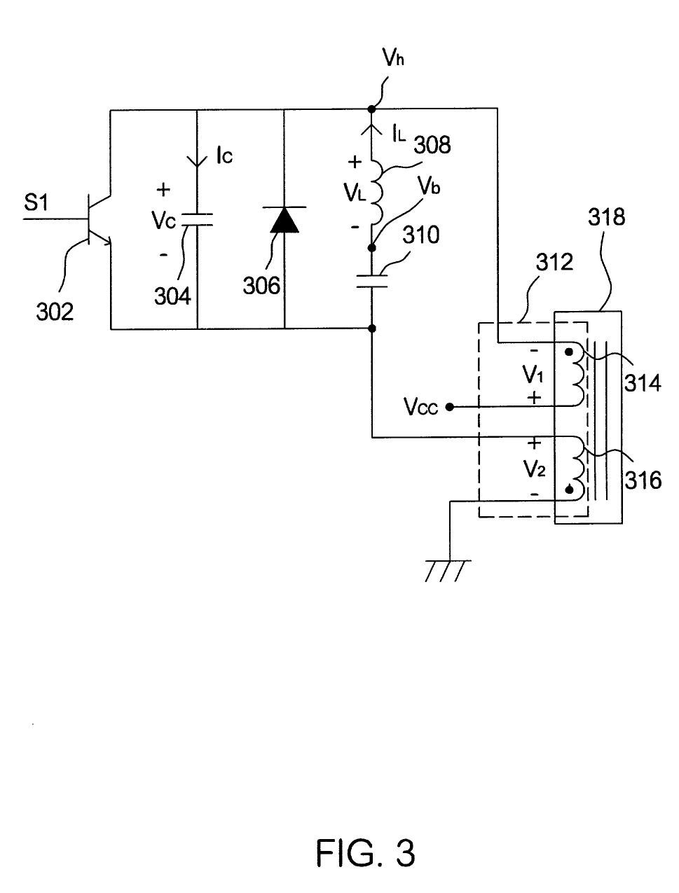

Referring to FIG. 3, it shows a schematic diagram of an equivalent circuit of a deflection yoke for a cathode-ray tube display, which has reduced electromagnetic radiation, according to a preferred embodiment of the invention. The deflection circuit includes a transistor 302, a capacitor 304, a damping diode 306, a flyback transformer 318 with primary winding 312, a capacitor 310, and a horizontal deflection yoke 308. Signal S1 is applied to the transistor 302 of the deflection circuit in order to turn the transistor 302 on or off. The primary winding 312 includes coils 314 and 316. One terminal of the coil 314 is coupled to the collector of the transistor 302, and the other terminal of that is coupled to the direct current (DC) supply V_{CC}. One terminal of the coil 316 is coupled to the emitter of the transistor 302 while the other terminal of that is coupled to ground. The coils 314 and 316 are identical in numbers of turns but are of opposite polarity.

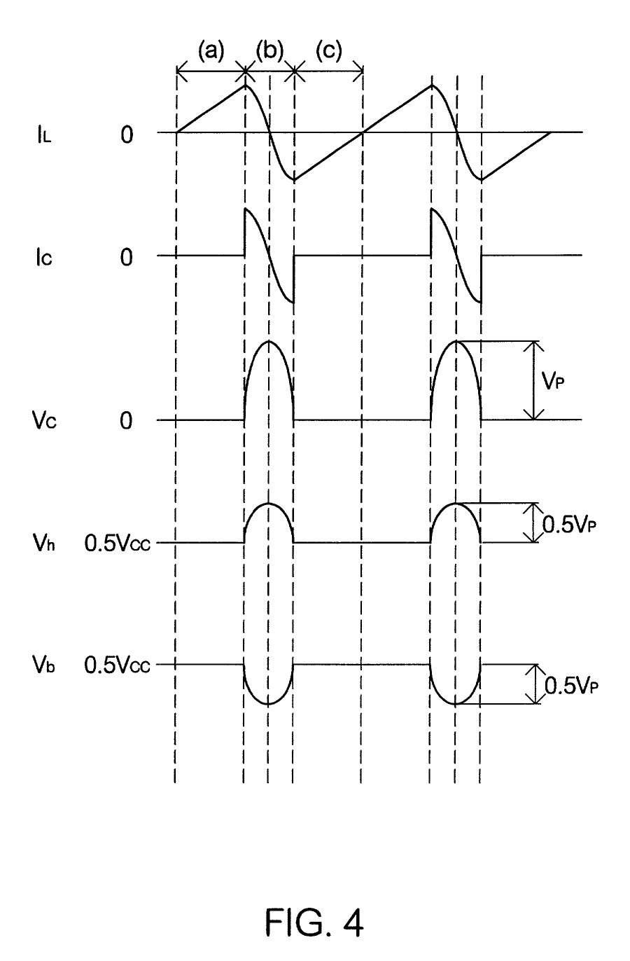

Referring to FIG. 4, it shows waveform diagrams of the voltage and currents of components in FIG. 3. I_{L} denotes the current flowing through the horizontal deflection yoke 308. I_{C} is the current of the capacitor 304 and V_{C} is the voltage across the capacitor 304. The horizontal deflection yoke 308 has two terminals that one has a high voltage Vₕ and the other has a low voltage V_{b}. V1 and V2 represent the voltages across the coils 314 and 316 respectively. In the start of the operation, the DC voltage V_{CC} charges the capacitor 310 so that the voltage across the capacitor 310 is equal to the voltage V_{CC}. During the period (a) in FIG. 4, the transistor 302 is turned on, a current flows from the capacitor 310 to the transistor 302 through the deflection yoke 308, such as an inductor, wherein the current increases linearly. During the period (b), the transistor 302 is turned off, and the capacitor 304 and the horizontal deflection yoke 308 begin to oscillate so that the currents I_{L} and I_{C} become sinusoidal. When the sinusoidal currents I_{C} and I_{L} reach their minimum values, the damping diode 306 is turned on and the operation of the circuit reaches the period (c) during which the current I_{L} flowing through the horizontal deflection yoke 308 is increasing linearly. Before the damping diode 306 turns off, if the transistor 302 is turned on, the current I_{L} flowing through the horizontal deflection yoke 308 will increase linearly. Thus, if the transistor 302 is switched on and off alternately, the current I_{L} flowing through the horizontal deflection yoke 308 becomes a sawtooth waveform current.

In addition, when the current I_{C} of the capacitor 304 varies, the capacitor 304 has a corresponding variation. As shown in FIG. 4, the voltage V_{C} across the capacitor 304 is correspondingly a train of pulses having an amplitude denoted by Vₚ. Since the coils 304 and 306 are of the same number of turns, the voltages V₁ and V₂ across the coils 304 and 306 are identical. Application of Kirchhoff's voltage law to a loop across the capacitor 304, the primary winding 312, and the DC voltage supply yields:

V_{CC}=V₁+V₂+V_{C}.

Thus,

V₁=V₂=0.5(V_{CC}−V_{C}).

The voltages V_{b} and Vₕ of the two terminals of the horizontal deflection yoke are:

V_{b}=V₁=0.5(V_{CC}−V_{C}) and

Vₕ=V_{C}+V_{b}=0.5(V_{CC}+V_{C}).

As shown in FIG. 4, during the period (a), the voltages V_{b} and Vₕ are fixed at 0.5V_{CC}. During the period (b), the voltage V_{b} is a pulse having an amplitude of 0.5V_{CC} while the voltage Vₕ is a pulse having an amplitude of 0.5V_{CC} but is of opposite polarity.

Hence, the voltages V_{b} and Vₕ at the two terminals of the horizontal deflection yoke are pulses of equal amplitude but opposite polarity. Thus, at positions which is equally apart from the two terminals of the horizontal deflection yoke, the electromagnetic radiation generated from the voltages V_{b} and Vₕ can be substantially cancelled. On the other hand, the distances from the position where a user usually sits in front of the display to the two terminals of the horizontal deflection yoke are much farther than the distance between the two terminals of the horizontal deflection yoke. In this regard, the user who sits in front of the display is about equally apart from the two terminals of the horizontal deflection yoke. As a result, the influence of the electromagnetic radiation from the horizontal deflection yoke on the user is effectively reduced to a minimum.

Besides, according to the invention, it is only required to modify the way of winding in the flyback transformer and the cathode-ray tube remains unchanged. In this way, it requires almost no additional power dissipation for the reduction of the undesired electromagnetic radiation. Thus, the electromagnetic radiation reduction is achieved and the cost is lowered.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for reducing radiation of a cathode-ray tube display, the cathode-ray tube display comprising a horizontal deflection circuit for deflecting an electron beam of the cathode-ray tube horizontally, the horizontal deflection circuit comprising a transistor, a damping diode, a capacitor, a compensation capacitor, and a horizontal deflection yoke, the damping diode coupled to the capacitor in parallel and coupled between a collector and an emitter of the transistor, the horizontal deflection yoke coupled between the collector of the transistor and the compensation capacitor, the compensation capacitor coupled between the horizontal deflection yoke and the emitter of the transistor, wherein the transistor, the damping diode, and the capacitor are used so that a sawtooth waveform current flows through the horizontal deflection yoke, and the compensation capacitor is used for compensating horizontal image distortion, the method comprising:
applying a first voltage signal and a second voltage signal to the collector and the emitter of the transistor respectively;
wherein the first voltage signal is a train of first pulses and the second voltage signals is a train of second pulses, the first and second pulses have equal amplitude, and the first and second pulses are of opposite polarity.

2. An apparatus for reducing radiation of a cathode-ray tube display, the cathode-ray tube display comprising a horizontal deflection circuit for deflecting an electron beam of the cathode-ray tube horizontally, the horizontal deflection circuit comprising a transistor, a damping diode, a capacitor, a compensation capacitor, and a horizontal deflection yoke, the damping diode coupled to the capacitor in parallel and coupled between a collector and an emitter of the transistor, the horizontal deflection yoke coupled between the collector of the transistor and the compensation capacitor, the compensation capacitor coupled between the horizontal deflection yoke and the emitter of the transistor, wherein the transistor, the damping diode, and the capacitor are used so that a sawtooth waveform current flows through the horizontal deflection yoke, and the compensation capacitor is used for compensating horizontal image distortion, the apparatus comprising:
a flyback transformer, the flyback transformer comprising a primary winding, the primary winding including a first coil and a second coil, a first terminal of the first coil coupled to the collector of the transistor and a second terminal of the first coil coupled to a direct current (DC) supply voltage, a first terminal of the second coil coupled to ground and a second terminal of the second coil coupled to the emitter of the transistor.

3. An apparatus according to claim 2, the first and second coils are identical in numbers of turns but are of opposite polarity.
